(19) United States
(12) Patent Application Publication
(10) Pub. No.: US 2023/0270135 A1
(43) Pub. Date: Aug. 31, 2023

(54) TEXTURIZED FOOD PRODUCTS CONTAINING INSOLUBLE PARTICLES AND METHODS FOR MAKING SUCH FOOD PRODUCTS

(71) Applicant: SOCIÉTÉ DES PRODUITS NESTLÉ S.A., Vevey (CH)

(72) Inventors: Patrick Pibarot, Patrick (CH); Christian Sanchez, Montpellier (FR); Marie-Hélène Morel, Montpellier (FR)

(21) Appl. No.: 18/143,251

(22) Filed: May 4, 2023

Related U.S. Application Data
(62) Division of application No. 16/842,888, filed on Apr. 8, 2020.
(60) Provisional application No. 62/831,834, filed on Apr. 10, 2019.

(51) Int. Cl. A23J 3/14; A23J 3/08; A23L 33/16; A23L 29/25; A23L 29/212; A23L 29/281; A23L 29/10; A23L 33/29

(52) U.S. Cl. CPC A23J 3/14; A23J 3/08; A23L 33/16; A23L 29/25; A23L 29/212; A23L 29/281; A23L 29/10; A23L 33/29

(57) ABSTRACT

A meat analogue may include a set protein emulsion, the protein emulsion having a protein and at least one insoluble particle. In some embodiments, at least a portion of the particle can include at least one mineral material selected from the group consisting of silicium, and calcium, such as one or more of rhombohedral calcite, scalenohedral calcite, silicon dioxide, and magnesium oxide; at least one organic material selected from the group consisting of a bone meal, a cartilage meal, a ground crustacean shell, a ground sea fish shell, and a ground egg shell; and/or a gelled vegetable gum, a gelled hydrocolloid, a polymerized vegetable gum, a polymerized hydrocolloid, or a mixture thereof. The meat analogue can be made by extruding the protein emulsion and cooling the extruded emulsion. The meat analogue can be cut into chunks and/or added to another comestible composition such as a gravy or broth.

### CROSS REFERENCE TO RELATED APPLICATIONS

This application claims priority to U.S. Provisional Application Ser. No. 62/831,834 filed Apr. 10, 2019 the disclosure of which is incorporated in its entirety herein by this reference.

### FIELD OF THE INVENTION

The invention relates generally to food compositions and particularly to meat analogues comprising a protein and insoluble particles.

### BACKGROUND

Existing processes for manufacturing food products that have the appearance and texture of meat (“meat analogs”) mainly use wheat gluten or soya protein isolates in an extrusion process. However, the way that these proteins achieve fibrous or lamellar structure is not really understood, and therefore formula modification or development of new products with specific structures is difficult.

For example, the replacement of wheat gluten or soya proteins by other animal or plant protein source leads to products of unsatisfactory structure and texture. Furthermore, the shape, texture and structure of reconstituted fibrous meat pieces are limited and mainly reproduce chicken or ham chunks. Meat analogs having a structure and a texture corresponding to beef, lamb or pork meat or any other reference meat piece are more difficult to manufacture.

These difficulties are principally due to the non-control of protein aggregation during the heating and cooling processes. Cooling of melted protein results in similar rheological and biochemical behavior and thus the same kind of structure, with some differences in firmness or elasticity for mouth texture, but minimal differences in visual structure.

In addition to flavor, control of both firmness/elasticity and visual properties is necessary to reproduce meat chunks that achieve good palatability or human consumer acceptance. Current processes and formula are not able to create structures and texture differences beyond the existing meat analog products.

### SUMMARY

The present inventors surprisingly found a way to control protein structuration in a meat analog production process. Specifically, the present inventors used an insoluble particle phase which interacts with melted proteins to allow control of the formation of fibrillary or lamellar protein structures.

Accordingly, in a general embodiment, the present disclosure provides a meat analog comprising an emulsion comprising a protein and insoluble particles. The protein emulsion comprises a protein and from about 1% to about 30% by weight of a particle, the particle having a solubility in water of about 0.0001 mg/L to about 25 mg/L at 25° C. and a median particle size of from about 0.05 μm to about 100 μm.

In another embodiment, the present disclosure provides a meat analogue made from the protein emulsion, wherein the meat analogue comprises a fibrous and lamellar structure.

In another embodiment, the present disclosure provides a food for an animal comprising a meat analogue made from the protein emulsion, wherein the meat analogue comprises a fibrous and lamellar structure. The animal is a human, a cat or a dog.

In one other embodiment, the present disclosure a method of producing a meat analogue, the method comprising:
mixing a protein, water and a particle to form a protein emulsion, wherein the emulsion comprises from about 1% to about 30% by weight of the particle having a solubility in water of about 0.0001 mg/L to about 25 mg/L at 25° C. and a median particle size of from about 0.05 μm to about 100 μm;
heating the emulsion to temperature of about 80° C. to about 200° C. by subjecting the emulsion to extrusion through a die; and
cooling the heated emulsion to form the meat analogue, wherein the meat analogue comprises a fibrous and lamellar structure.

### BRIEF DESCRIPTION OF THE FIGURES

The patent or application file contains at least one drawing executed in color. Copies of this patent or patent application publication with color drawing(s) will be provided by the Patent Office upon request and payment of the necessary fee.

FIG. 1 is a table showing non-limiting examples of insoluble particle materials suitable for methods and compositions according to the present disclosure.

FIG. 2 is a table listing non-limiting examples of precipitated calcium carbonate materials suitable for methods and compositions according to the present disclosure.

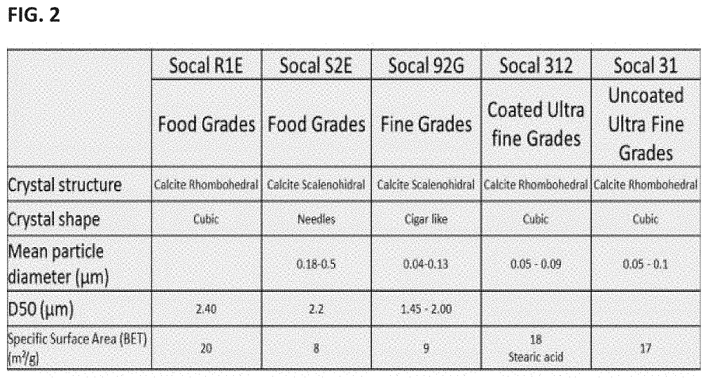

FIG. 3 is a table showing recipes used in Example 1 in the present disclosure.

FIG. 4 is a table showing the results of the mechanical tests with slabs of Recipe 1 and Recipe 3 from Example 1 in the present disclosure.

FIG. 5 is a table listing insoluble particles tested in Example 2 in the present disclosure and their main characteristics.

FIG. 6 contains a table providing a description of “Recipe gluten-1” used in Example 2 in the present disclosure, a description of the associated parameters, and a photograph of the obtained structure.

FIG. 7 contains a table providing a description of “Recipe gluten-2” used in Example 2 in the present disclosure, a description of the associated parameters, and a photograph of the obtained structure.

FIG. 8 contains a table providing a description of “Recipe gluten-3” used in Example 2 in the present disclosure, a description of the associated parameters, and a photograph of the obtained structure.

FIG. 9 contains a table providing a description of “Recipe gluten-4” used in Example 2 in the present disclosure, a description of the associated parameters, and a photograph of the obtained structure.

FIG. 10 contains a table providing a description of “Recipe gluten-5” used in Example 2 in the present disclosure, a description of the associated parameters, and a photograph of the obtained structure.

FIG. 11 contains a table providing a description of “Recipe gluten-6” used in Example 2 in the present disclosure, a description of the associated parameters, and a photograph of the obtained structure.

FIG. 12 contains a table providing a description of “Recipe gluten-7” used in Example 2 in the present disclosure, a description of the associated parameters, and a photograph of the obtained structure.

FIG. 13 contains a table providing a description of “Recipe gluten-8” used in Example 2 in the present disclosure, a description of the associated parameters, and a photograph of the obtained structure.

FIG. 14 contains a table providing a description of “Recipe gluten-9” used in Example 2 in the present disclosure, a description of the associated parameters, and a photograph of the obtained structure.

FIG. 15 contains a table providing a description of “Recipe gluten-10” used in Example 2 in the present disclosure, a description of the associated parameters, and a photograph of the obtained structure.

FIG. 16 contains a table providing a description of “Recipe gluten-11” used in Example 2 in the present disclosure, a description of the associated parameters, and a photograph of the obtained structure.

FIG. 17 contains a table providing a description of “Recipe gluten-12” used in Example 2 in the present disclosure, a description of the associated parameters, and a photograph of the obtained structure.

FIG. 18 contains a table providing a description of “Recipe gluten-13” used in Example 2 in the present disclosure, a description of the associated parameters, and a photograph of the obtained structure.

FIG. 19 contains a table providing a description of “Recipe gluten-14” used in Example 2 in the present disclosure, a description of the associated parameters, and a photograph of the obtained structure.

FIG. 20 contains a table providing a description of “Recipe gluten-15” used in Example 2 in the present disclosure, a description of the associated parameters, and a photograph of the obtained structure.

FIG. 21 contains a table providing a description of “Recipe gluten-16” used in Example 2 in the present disclosure, a description of the associated parameters, and a photograph of the obtained structure.

FIG. 22 contains a table providing a description of “Recipe gluten-17” used in Example 2 in the present disclosure, a description of the associated parameters, and a photograph of the obtained structure.

FIG. 23 contains a table providing a description of “Recipe gluten-18” used in Example 2 in the present disclosure, a description of the associated parameters, and a photograph of the obtained structure.

FIG. 24 contains a table providing a description of “Recipe gluten-19” used in Example 2 in the present disclosure, a description of the associated parameters, and a photograph of the obtained structure.

### DETAILED DESCRIPTION

Definitions

Some definitions are provided hereafter. Nevertheless, definitions may be located in the “Embodiments” section below, and the above header “Definitions” does not mean that such disclosures in the “Embodiments” section are not definitions.

As used in this disclosure and the appended claims, the singular forms “a,” “an” and “the” include plural referents unless the context clearly dictates otherwise. Thus, for example, reference to “a composition” or “the composition” includes two or more compositions. The term “and/or” used in the context of “X and/or Y” should be interpreted as “X,” or “Y,” or “X and Y.” Similarly, the term “at least one of” used in the context of “at least one of X or Y” should be interpreted as “X,” or “Y,” or “X and Y.” Where used herein, the term “example,” particularly when followed by a listing of terms, is merely exemplary and illustrative, and should not be deemed to be exclusive or comprehensive.

As used herein, “about” is understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. A range that is “between” two values includes those two values. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All percentages expressed herein are by weight of the total weight of the meat analog and/or the corresponding emulsion unless expressed otherwise. When reference is made to the pH, values correspond to pH measured at 25° C. with standard equipment.

The terms “food,” “food product” and “food composition” mean a product or composition that is intended for ingestion by an animal, including a human, and provides at least one nutrient to the animal. The term “pet food” means any food composition intended to be consumed by a pet. The term “pet” means any animal which could benefit from or enjoy the compositions provided by the present disclosure. For example, the pet can be an avian, bovine, canine, equine, feline, hircine, lupine, murine, ovine, or porcine animal, but the pet can be any suitable animal. The term “companion animal” means a dog or a cat.

A “blended” composition merely has at least two components having at least one different characteristic relative to each other, preferably at least moisture content and water activity in the context of the present disclosure. In this regard, description of a composition as “blended” does not imply that the blended composition has been subjected to processing sometimes referenced as “blending,” namely mixing components so that they are indistinguishable from each other, and preferably such processing is avoided when mixing the meat analog with another comestible composition (e.g., a gravy or broth) to form the blended composition disclosed herein.

A “dry” food composition has less than 10 wt. % moisture and/or a water activity less than 0.64, preferably both. A “semi-moist” food composition has 11 wt. % to 20 wt. % moisture and/or a water activity of 0.64 to 0.75, preferably both. A “wet” food composition has more than 20 wt. % moisture and/or a water activity higher than 0.75, preferably both.

A “meat analog” is a meat emulsion product that resembles pieces of natural meat in appearance, texture, and physical structure. A meat analog does not necessarily include meat; for example, some embodiments of a meat analog lack meat and instead use vegetable protein such as gluten to achieve the appearance, texture, and physical structure of meat.

The compositions disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein unless explicitly and directly stated otherwise.

Embodiments

One embodiment provides a protein emulsion comprising a protein and from about 1% to about 30% by weight of an added insoluble particle, the particle having a solubility in water of about 0.0001 mg/L to about 25 mg/L at 25° C. and a median particle size of from about 0.05 μm to about 100 μm.

In an embodiment, the particle is selected from the group consisting of a mineral material, on organic material, or mixtures thereof.

In an embodiment, at least a portion of the insoluble particles comprise at least one mineral material selected from the group consisting of silicium, carbon and calcium.

In an embodiment, at least a portion of the insoluble particles comprise at least one mineral material selected from the group consisting of calcium carbonate, calcium sulfate, silicon dioxide, and magnesium oxide.

In an embodiment, at least a portion of the insoluble particles comprise calcite.

In an embodiment, at least a portion of the insoluble particles comprise at least one mineral material selected from the group consisting of rhombohedral calcite, scalenohedral calcite, silicon dioxide, and magnesium oxide.

In an embodiment, at least a portion of the insoluble particles comprise at least one organic material selected from the group consisting of a bone meal, a cartilage meal, a ground crustacean shell, a ground sea fish shell, a ground egg, analogue gelled vegetable gum, a gelled hydrocolloid, a polymerized vegetable gum, starch, heat resistant starch, a polymerized hydrocolloid, and mixtures thereof.

In an embodiment, at least a portion of the insoluble particles are selected from the group consisting of a gelled vegetable gum, a gelled hydrocolloid, a polymerized vegetable gum, a polymerized hydrocolloid, and mixtures thereof.

In an embodiment, the insoluble particles comprise a first portion that is calcium carbonate and a second portion that is heat resistant starch.

In an embodiment, the insoluble particles have at least one characteristic selected from the group consisting of a diameter of about 0.05 μm to about 100 μm, a bulk density of about 0.5 g/cm³ to about 5 g/cm³, and a specific surface area of 1 m²/g to 20 m²/g.

In an embodiment, the insoluble particles have a coating. The coating can comprise stearate.

In an embodiment, the protein is about 25 wt. % to about 55 wt. % of the emulsion.

In an embodiment, the emulsion comprises about 4 wt. % to about 9 wt. % fat.

In an embodiment, the emulsion comprises about 45 wt. % to about 80 wt. % by weight moisture.

In an embodiment, the emulsion comprises at least one meat selected from the group consisting of poultry, beef, pork and fish, and the at least one meat provides at least a portion of the protein.

In an embodiment, the emulsion comprises a vegetable protein that provides at least a portion of the protein.

In an embodiment, the emulsion comprises a vegetable protein that provides at least a portion of the protein, and the emulsion does not contain meat.

In an embodiment, the emulsion does not contain at least one of gluten, soy or cereal.

In an embodiment, the present disclosure provides a meat analogue made from a protein emulsion, wherein the meat analogue comprises a fibrous and lamellar structure.

In an embodiment, the present disclosure provides a food for an animal comprising a meat analogue, the meat analogue made from the protein emulsion, wherein the meat analogue comprises a fibrous and lamellar structure. The animal can be a human, a cat, or a dog.

In an embodiment, the insoluble particles are about 5% to about 30% v/v of the emulsion.

In another embodiment, the present disclosure provides a method of producing a meat analogue. The method comprises: mixing a protein, water and insoluble particles to form a protein emulsion; heating the emulsion; and cooling the heated emulsion to form the meat analogue.

In an embodiment, the method provides producing a meat analogue, the method comprising: mixing a protein, water and a particle to form an emulsion, wherein the emulsion comprises from about 1% to about 30% by weight of an added insoluble particle, the particle having a solubility in water of about 0.0001 mg/L to about 25 mg/L at 25° C. and a median particle size of from about 0.05 μm to about 100 μm; heating the emulsion to temperature of about 80° C. to about 200° C. by subjecting the emulsion to extrusion through a die; and cooling the heated emulsion to form the meat analogue, wherein the meat analogue comprises a fibrous and lamellar structure.

In an embodiment, a heat exchanger is used to cool the heated emulsion.

In an embodiment, the method comprises cutting the meat analogue to form chunks. The method can comprise combining the chunks with another comestible composition to form a blended food composition; and retorting or pasteurizing the blended food composition in a container.

In an embodiment, the heating of the emulsion is to a temperature of about 140 to about 250° C. The emulsion is prepared in a location selected from the group consisting of (i) a mixer from which the emulsion is pumped into the extruder and (ii) in the extruder by separately feeding powder and liquid into the extruder.

In an embodiment, the method comprises directing the emulsion through a die selected from the group consisting of a coat hanger die, a fish tail die, and a combination thereof. The method can comprise maintaining a temperature of the die at about 80° C. to about 90° C.

In another embodiment, the present disclosure provides a method of providing nutrition to a pet. The method comprises administering to the pet a meat analogue comprising an emulsion comprising a protein and insoluble particles.

In another embodiment, the present disclosure provides a method of formulating a meat analogue to have a desired structure, the method comprising selecting one or more of a size, a shape, a deformability or a chemical-physical property of insoluble particles that are included in an emulsion that is at least a portion of the meat analogue. The desired structure can comprise one or more of a fiber diameter, a fiber length or a fiber arrangement. The method can further comprise selecting one or more of a heating kinetic profile, a cooling kinetic profile, a process flow rate, or a cooling die geometrical design.

The present inventors recognized that meat analog manufacturing processes are based on protein heating, which results in protein viscosity reduction to very fluid media, followed by a cooling step, which leads to protein re-polymerization with a structure that depends on flow characteristics at the time of product solidification. Therefore, the melted protein flow pattern at the cooling step impacts stability of a specific structure. The melted flow pattern depends on protein visco-elastic properties, on dough rheological behavior in the cooling die, and on solid material in the dough which may interrupt and/or disturb or orient melted protein flows.

Therefore, an aspect of the present disclosure is a method of producing a meat analog, the method comprising using insoluble particles of defined size, shape and surface properties to control melted protein flow during the cooling step of the method in order to achieve a targeted protein structure. The meat analog can be a petfood.

The insoluble particles can be part of raw material used to make the meat analog, for example ground carcasses or fish frames, or can be added as a powder, for example calcium carbonate powder. The insoluble particles can be of mineral origin (e.g., silicium, bentonite, carbon or calcium) or organic origin (e.g., bone meals, ground crustacean or sea fish shells, or egg shell powders). The particles may include insoluble particles texturized vegetable proteins or micronized vegetable materials, hulls (for instance pea hulls), nuts, fibers (for instance carrot or wheat), and/or particles that yield strain softening which in turn accentuates the periodical instability. A non-limiting example of a mineral particle suitable for one or more embodiments is calcium carbonate. In some embodiments, the insoluble particles can be from gelation or polymerization of vegetable gums or hydrocolloids (e.g., starch granules, pectin, cellulose and derivatives thereof).

One or more of the size, shape, deformability and chemical-physical properties of the insoluble particles can be adjusted or selected to orient dough transformation during heating and cooling under longitudinal flow to achieve a specific targeted structure. In some embodiments, the targeted structure includes variation of fiber diameters and lengths and/or specific fiber arrangement in space dimensions.

For example, the fibers can associate in micro-ropes and/or can associate to form parallel sheets formed of micro-fibers or formed by the micro-ropes. In some embodiments, the insoluble particles can be ordered in specific patterns depending on the viscoelastic behavior of the melted proteins and depending on the geometrical and physical properties of the insoluble particles themselves. The interactions between the insoluble particles and the melted protein can also play an important role. These complex interactions can result in controlled flow patterns stabilized by protein aggregation under dynamic cooling. These stabilized and freeze flow patterns can provide the final structure of the meat analog product.

The flow pattern of the composite media comprising protein and insoluble particles can depend on one or more of heating kinetic profile, cooling kinetic profile, process flow rate, or cooling die geometrical design. A slow cooling kinetic profile associated with laminar flow can result in a more ordered structure, while a short time cooling profile and/or a turbulent flow can result in a more disordered structure.

A mechanism that can achieve visible fibrous or lamellar structures is separation between insoluble polymerized protein fibers and more soluble/gellified media between the protein insoluble fibers. Phase properties of the insoluble particles can be used to favor and enhance this phase separation by modifying water repartition and by creating local interruption of protein flow and local instability in water absorption by the proteins.

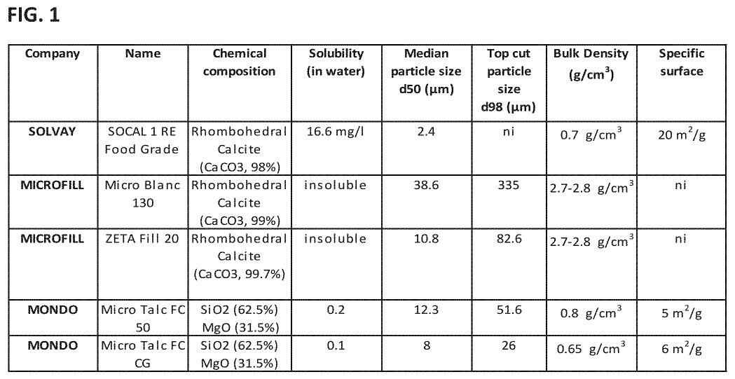

The insoluble particles can be from any source. In an embodiment the insoluble particles are from a mineral source. The table in FIG. 1 provides non-limiting examples of suitable mineral particles.

The mineral particles can have a crystalline form (e.g. rhombohedral or scalenohedral) that can be from different chemical origins. The size of the mineral particles and the size of the particle aggregates can vary from a diameter of about 0.05 μm to a diameter of about 100 μm, for example 1-20 μm or 2-10 μm. The bulk density and porosity of the mineral particles can be about 0.5 g/cm³ to about 5 g/cm³. The specific surface area of the particle powder can be about 1 m²/g to about 20 m²/g. These physical parameters can influence the structuring effect of the insoluble particles on the fibrous or lamellar structure of the resultant meat analog product.

Additionally or alternatively, the source of the insoluble particles can be micro-ground bones, cartilage or fish frame in the form of ground fresh or frozen materials or as meals (e.g., bone meals such as pork bone meal). A non-limiting example of insoluble particles suitable for one or more embodiments is a combination of mineral particles (e.g., calcium carbonate) and heat resistant starch.

Another aspect of the present disclosure is a method of providing nutrition to a pet, for example a companion animal. The method comprises administering any of the meat analogs disclosed herein to the pet, preferably by oral administration in a petfood.

In an embodiment, the meat analog can be made by a process comprising combining water, protein (e.g., protein meal such as meat meal) and insoluble particles in a mixer (e.g., a planetary mixer) to make a dough. As a non-limiting example, meat powder can be mixed with gluten powder and then water at maximum temperature 10° C. can be added. In some embodiments, the insoluble particles are about 5% to about 30% v/v of the emulsion, for example about 5% to about 15% v/v of the emulsion or about 5% to about 10% v/v of the emulsion.

Non-limiting examples of suitable meats for the emulsion include poultry, beef, pork, fish and mixtures thereof. Non-limiting examples of suitable non-meat proteins include wheat protein (e.g., whole grain wheat or wheat gluten such as vital wheat gluten), corn protein (e.g., ground corn or corn gluten), soy protein (e.g., soybean meal, soy concentrate, or soy isolate), canola protein, rice protein (e.g., ground rice or rice gluten), cottonseed, peanut meal, pulse proteins (e.g. pea protein, faba bean protein), whole eggs, egg albumin, milk proteins, and mixtures thereof.

In some embodiments, the emulsion comprises a meat and comprises gluten (e.g., wheat gluten). In alternative embodiments, the emulsion comprises a meat and does not comprise any gluten.

In some embodiments, the emulsion comprises a non-meat protein such as gluten (e.g., wheat gluten), and does not comprise meat or meat by-products. In alternative embodiments, the emulsion comprises a non-meat protein and does not comprise any gluten or any meat or meat by-products.

In some of the embodiments disclosed above, the emulsion does not contain soy and/or does not contain corn or other cereal-based ingredients (e.g., amaranth, barley, buckwheat, fonio, millet, oats, rice, wheat, rye, sorghum, triticale, or quinoa). In some embodiments, the raw material may comprise pea protein and faba bean protein, or may comprise pea protein, faba bean protein, and rice, or may comprise pea protein, faba bean protein, and gluten.

In an embodiment, the emulsion comprises a flour and thus is a dough. If flour is used, it will also provide some protein. Therefore, a material can be used that is both a vegetable protein and a flour. A non-limiting example of a suitable flour is a starch flour, such as cereal flours, including flours from rice, wheat, corn, barley, and sorghum; root vegetable flours, including flours from potato, cassava, sweet potato, arrowroot, yam, and taro; and other flours, including sago, banana, plantain, and breadfruit flours. Another non-limiting example of a suitable flour is a legume flour, including flours from beans such as favas, lentils, mung beans, peas, chickpeas, and soybeans.

Additionally or alternatively, the raw material may optionally comprise a protein isolate. If a protein isolate is used, the raw material may include, for example, protein isolate from faba bean, lentils, or mung beans.

In some embodiments, the emulsion can comprise a fat such as an animal fat and/or a vegetable fat. In an embodiment, the fat source is an animal fat source, such as chicken fat, tallow or grease. Vegetable oils, such as corn oil, sunflower oil, safflower oil, rapeseed oil, soybean oil, olive oil and other oils rich in monounsaturated and polyunsaturated fatty acids, can be used additionally or alternatively. In some embodiments, a source of omega-3 fatty acids is included, such as one or more of fish oil, krill oil, flaxseed oil, walnut oil, or algal oil.

The emulsion can include other components in addition to the protein and optional flour, for example one or more of a vitamin, a mineral, a preservative, a colorant or a palatant.

Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like.

Non-limiting examples of suitable preservatives include potassium sorbate, sorbic acid, sodium methyl para-hydroxybenzoate, calcium propionate, propionic acid, and combinations thereof. Non-limiting examples of suitable colorants include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan. Non-limiting examples of suitable palatants include yeast, tallow, rendered animal meals (e.g., poultry, beef, lamb, and pork), flavor extracts or blends (e.g., grilled beef), animal digests, and the like.

The prepared dough can be charged in a piston pump and installed at the entrance of an extruder (e.g., twin screw). Then the dough can be extruded, for example with the extruder at a speed of about 200 to about 400 rpm, at a temperature of about 140° C. to about 250° C.

In some embodiments, instead of preparing the dough and pumping it into the extruder, the process can comprise feeding powder and liquid separately into the extruder.

In an embodiment, the emulsion is under a pressure of approximately 40 to about 200 psi, or about 60 to 100 psi in the extruder. The high temperature, along with the increased pressure, provides fiber-like definition to the product (e.g., linear alignment with smaller long fibers).

In an embodiment, the extruder has a coat hanger short die (CHSD). In one embodiment, the CHSD temperature is between about 80° C. and about 90° C. for obtaining the most appropriate texture.

In some embodiments, the meat analog can be made by a process comprising applying microwaves and/or radio-frequency waves to the dough to heat the dough. After the heating, the resultant texturized product can be cooled, shaped, and cut into suitably sized pieces.

In some embodiments, a gravy may be prepared by heating a mixture of water, starch and condiments. The meat analogs and gravy can be filled into cans in the desired proportions to form a blended pet food, and the cans can be vacuum sealed and then retorted under time-temperature conditions sufficient to effect commercial sterilization. Conventional retorting procedures may be used, for example a retorting temperature of about 118° C. to 121° C. for approximately 40 to 90 minutes to produce a commercially sterile product.

For example, the chunks can be mixed with another comestible composition such as gravy (e.g., a starch and/or a gum in water), broth in which another comestible composition has been simmered, vegetables (e.g., potatoes, squash, zucchini, spinach, radishes, asparagus, tomatoes, cabbage, peas, carrots, spinach, corn, green beans, lima beans, broccoli, brussel sprouts, cauliflower, celery, cucumbers, turnips, yams and mixtures thereof), condiments (e.g., parsley, oregano, and/or spinach flakes), or kibbles.

Some embodiments of a method of making the highly texturized meat analog disclosed herein (e.g., meat analog chunks) use one or more steps of the processes disclosed in U.S. Pat. Nos. 6,379,738; 6,649,206; and 7,736,676, each assigned to the Applicant of the present application and fully incorporated herein by reference in its entirety.

For example, an emulsion can be formed from meat, in some embodiments comprising natural meat materials (i.e., skeletal tissue and non-skeletal muscle) from one or more of mammals, fish or fowl, and/or meat by-products. The meat and/or meat by-products can be selected from a wide range of components, with the type and amount of meat material depending on a number of considerations, such as the intended use of the product, the desired flavor of the product, palatability, cost, availability of ingredients, and the like. The term meat material as used herein includes non-dehydrated meat and/or meat by-products, including frozen materials.

Additionally or alternatively to the meat, the emulsion may comprise one or more other proteinaceous materials, for example wheat gluten, soy flour, soy protein concentrate, soy protein isolate, egg albumin, or nonfat dry milk. If another proteinaceous material is included in the meat emulsion, the amount of the other proteinaceous material may vary from about 5 wt. % to about 35 wt. % by weight of the emulsion, depending on such factors as the intended use of the product, the quality of meat material used in the emulsion, ingredient cost considerations, and the like. In a preferred embodiment, the level of the other proteinaceous material is between about 25 wt. % and about 35 wt. % by weight, for example between about 28 wt. % and about 31 wt. % by weight. Generally, as the fat content and/or moisture content of the meat material used are increased, the level of other proteinaceous material in the emulsion is increased accordingly.

The formulation of the meat emulsion may vary widely, but nevertheless, the emulsion should have a protein to fat ratio sufficient to form a firm meat emulsion product upon coagulation of the protein with no sign of emulsion instability. The protein content of the emulsion should enable the emulsion, upon being heated to a temperature above the boiling point of water, to coagulate and form a firm emulsion product within about five minutes, or about within three minutes, after being heated to such a temperature. Thus, the meat materials, the dry proteinaceous material (if used) and any additives can be mixed together in proportions such that the meat material is present in an amount between about 50 wt. % to 75 wt. % by weight, or from about 60 wt. % to about 70 wt. % by weight of the meat emulsion. In a preferred embodiment, the starting ingredients for the meat emulsion comprise about 29 wt. % to about 31 wt. % by weight protein and about 4 wt. % to about 9 wt. % by weight fat, for example about 4 wt. % to about 6 wt. % by weight fat. The resultant meat emulsion product should have a substantially similar profile to that of the starting ingredients; however, if gravy or broth is added to the product, this profile could change due to the moisture, protein and/or fat content of the gravy/broth.

In some embodiments, the meat emulsion is formulated to contain between about 45 wt. % and about 80 wt. % by weight moisture, or between about 49 wt. % and about 56 wt. % by weight of the meat emulsion, or between about 52 wt. % and about 56 wt. % by weight of the meat emulsion. The exact concentration of water in the emulsion depends on the amount of protein and fat in the emulsion.

The preparation of the meat emulsion can comprise comminuting the uniformly heated mixture of ground meat particles under conditions which emulsify the meat material and form a meat emulsion in which the protein and water of the meat mixture form a matrix that encapsulates the fat globules. The meat material may be emulsified by a mixer, a blender, a grinder, a silent cutter chopper, an emulsion mill, or any other device capable of breaking and dispersing the fat as globules in the meat mixture to form an emulsion.

The additives to be incorporated in the emulsion, including any proteinaceous material and the insoluble particles, may be added to the meat prior to emulsification. Alternatively, the additives can be added to the meat after emulsification of the meat.

Then the meat emulsion can be comminuted again to increase the fineness of the emulsion and rapidly heated to a temperature above the boiling point of water, at which temperature the coagulation of protein in the emulsion can proceed so rapidly that the emulsion is set and a firm emulsion product formed within a very short period of time, e.g., twenty seconds or less.

At this stage in the process, the emulsion can be under a pressure of approximately 40 to about 200 psi or about 60 to 100 psi. The high temperature, along with the increased pressure, can provide fiber definition to the product, for example linear alignment with smaller long fibers.

In some embodiments, the emulsion is processed in equipment wherein the emulsion is heated to such elevated temperatures while being comminuted, for example by mechanical heating and/or steam injection. When the emulsion has been heated to such an elevated temperature in this manner, further significant shearing and cutting of the emulsion should be avoided. Control of the emulsion temperature within the desired range can be effected by adjusting such factors as the feed rate into the emulsion mill, the rotational speed of the emulsion mill, and the like, and can readily be determined by those skilled in the art.

The product can be pumped at high pressures of about 80 psi to about 600 psi, or about 100 psi to about 500 psi, and or about 140 psi to about 200 psi into the processing zone. The period of time required for the hot emulsion to set sufficiently to form a firm product can depend on a number of factors, such as the temperature to which the emulsion is heated and the amount and type of protein in the emulsion. In an embodiment, a residence time of about 5 seconds to about 3 minutes, or between about 1 to about 1.5 minutes, in the elongated tube can be sufficient for the protein to sufficiently coagulate and form a firm emulsion product which will retain its shape, integrity, and physical characteristics.

In an embodiment, the set meat emulsion pieces can be discharged from the confined processing zone as long strips of products with the pieces varying in size. Upon discharge from the processing zone, the pieces can be rapidly cooled by evaporating. If desired, suitable cutting means, such as a rotary cut-off knife, a water jet knife, a knife grid, or the like may be mounted at the discharge end of the elongated tube to cut the product into pieces of a desired size. If desired, the product may be cut down the center to allow the product to more rapidly cool. The meat emulsion chunks thus formed have excellent integrity and strength and will retain their shape and fiber characteristics when subjected to commercial canning and retorting procedures such as those required in the production of canned foods having a high moisture content.

An advantage of one or more embodiments provided by the present disclosure is the ability to use a variety of protein sources for manufacturing meat analogues. Another advantage of one or more embodiments provided by the present disclosure is to improve existing meat analogue production processes. Yet another advantage of one or more embodiments provided by the present disclosure is the ability to create new food concepts comprising meat analogue. Still another advantage of one or more embodiments provided by the present disclosure is to manufacture a meat analogue product with less or no cereal proteins. Another advantage of one or more embodiments provided by the present disclosure is gluten-free meat analogues. Yet another advantage of one or more embodiments provided by the present disclosure is to facilitate structuration of analogues that resemble any desired reference meat (e.g., beef, lamb or pork). Still another advantage of one or more embodiments provided by the present disclosure is to use insoluble particles to produce food products having a fibrillary or lamellar structure. Another advantage of one or more embodiments provided by the present disclosure is food product textural modification by physical treatment, for example a wet food for a companion animal.

Additional features and advantages are described herein and will be apparent from the description herein and the Figures.

### EXAMPLES

The following non-limiting examples are illustrative of embodiments provided by the present disclosure.

### Example 1

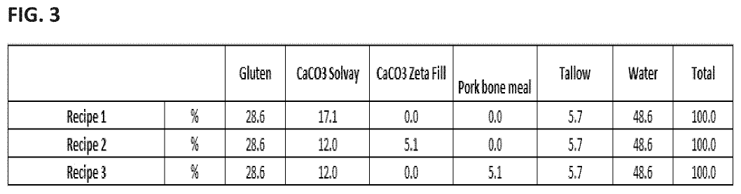

Trials were performed with the recipes set forth in FIG. 3. A part of the water (about 30 wt. %) was mixed with fat (tallow) and an insoluble particles powder in a high shearing mixer to produce a homogeneous and stable suspension. This mixture as then poured in a kneading mixer, and gluten powder was added progressively. Mixing was applied for three minutes at fifty rpm to obtain a dough. The process temperature at the mixer was adjusted from 150° C. to 170° C., and a highly texturized product was obtained with clear lamellar or fibrous structures.

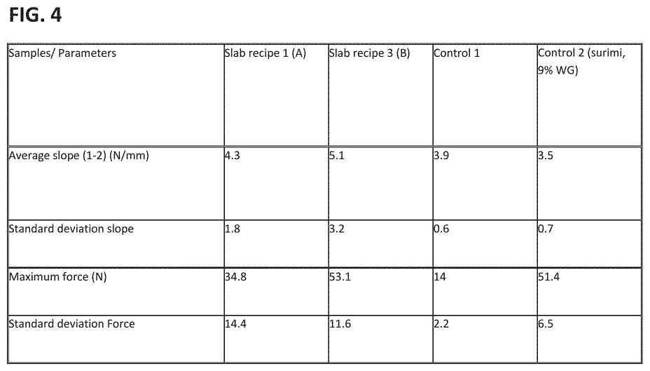

The obtained slabs were compared with two known meat analogs in terms of mechanical properties with a texturometer. The test consisted of measuring the force (N) during displacement of a probe through the samples. The probe had a 12 mm diameter shape, and probe speed was 2 mm·sec⁻¹. The curve of force as a function of descending distance was recorded, and curve slope as well as force at 4 mm penetration were calculated or recorded. Results of the mechanical tests with the slabs of Recipes 1 and 3 are shown in FIG. 4.

The slabs of Recipes 1 and 3 resulted in firmness and elasticity equivalent to that of known meat analogs as shown by the slope values and standard deviations. The force at breaking for Recipe 1 was higher than the first known meat analog and lower than the second known meat analog. For Recipe 3 in which a part of carbonate was replaced by pork bone meal, the force at breaking was larger and reached a level equivalent to the second known meat analog and significantly higher than the first known meat analog.

These experimental results show that addition of insoluble particles improved the structuration and texturization of the gluten slabs. Specifically, these tests demonstrated that the particles phase has a significant impact on melted protein behavior during the cooling phase. The pertinent use of insoluble particles with targeted properties constitutes a way to control melted protein structuration during cooling and to create products with new textures for completing the range of pet food and other meat analog products.

### Example 2

This example is a systematic investigation about the impact of particle sizes, shapes, and nature on protein structuration. With gluten dough, particle granulometry is identified as the main factor having an impact on gluten slab continuity and homogeneity. Particle shapes also have an impact, mainly between fibers and more or less spherical aggregates. Particle hydrophobicity also has a significant impact, demonstrating that water/protein interaction is another key factor in protein structuration.

One of the most interesting results was obtained by replacing 30% v/v of precipitated calcium carbonate by heat resistant starch. An organized, complex and multidimensional structure was achieved, demonstrating the importance of the global rheology of the system (viscosity) to achieve a given structure.

Trials were performed with a laboratory scale extruder (TSE 16 mm) and with a coat hanger cooling die (CHSD, annex 1).

The first trials were performed with precipitated calcium carbonate particles (PCC) as the insoluble particle phase. These PCC 1RE particles have a controlled granulometry with a D₅₀ size around 2.4 μm and a cubic shape and agglomerate in essentially spherical objects. Then a range of particles with different sizes, shapes and natures were selected to investigate the impact of insoluble phase characteristics on protein structuration.

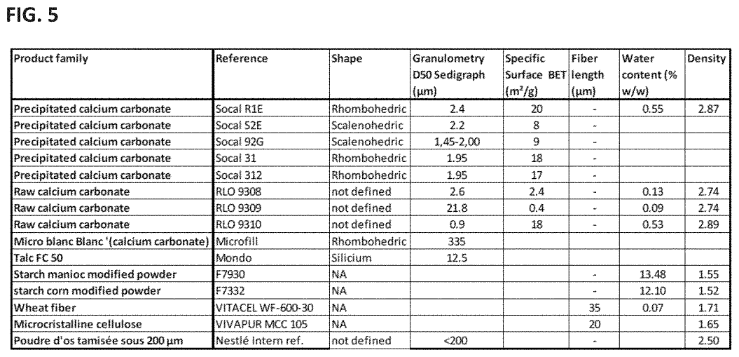

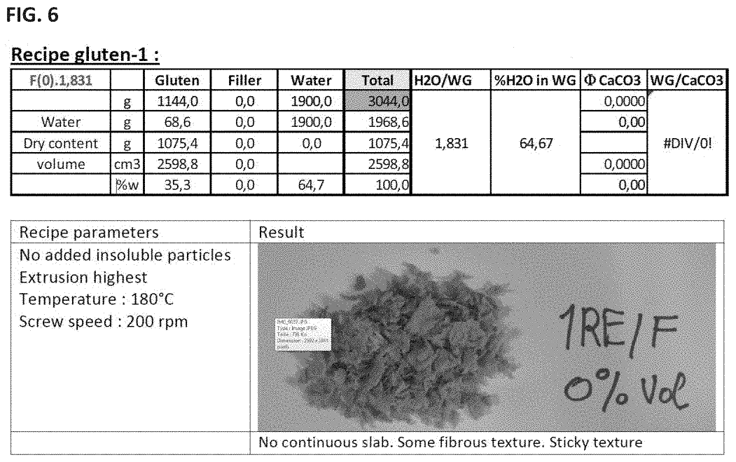

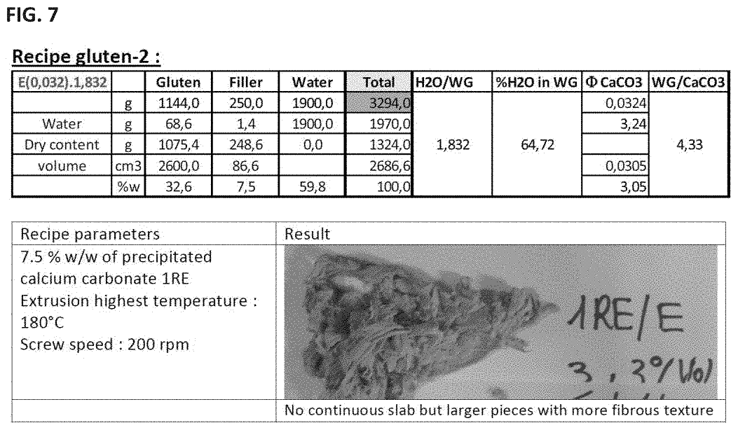

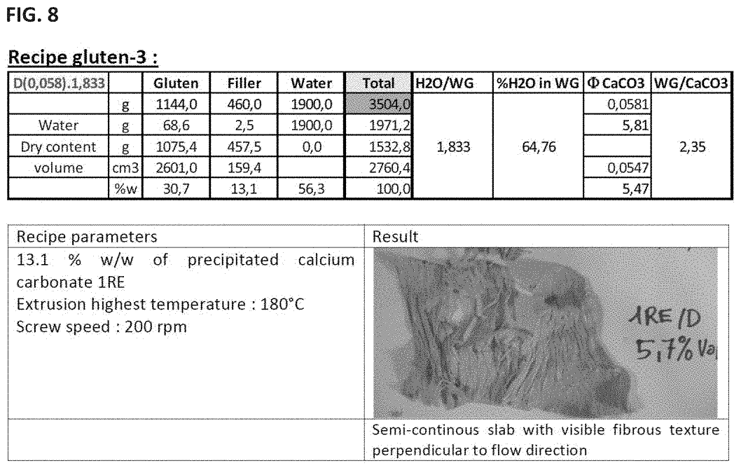

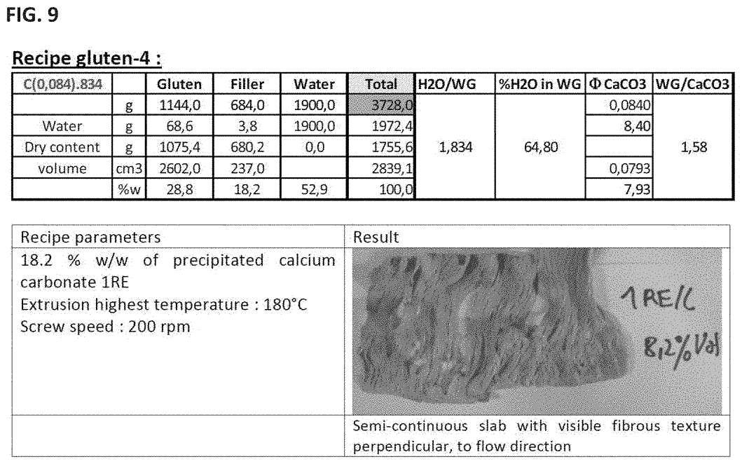

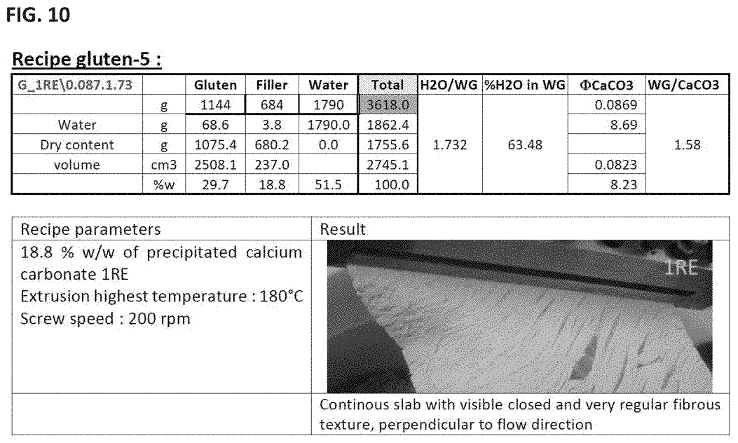

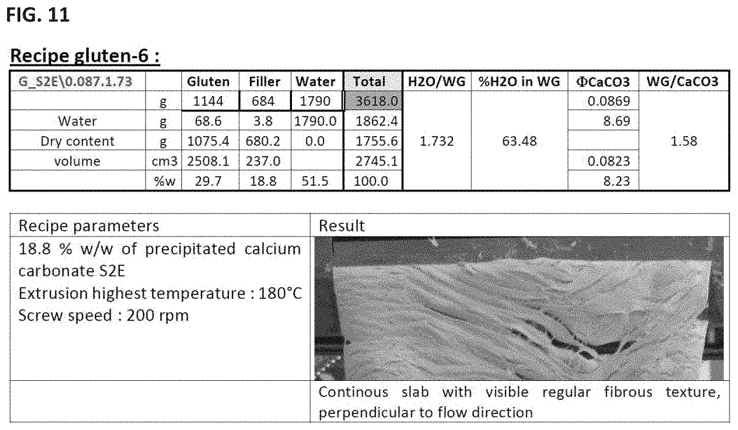

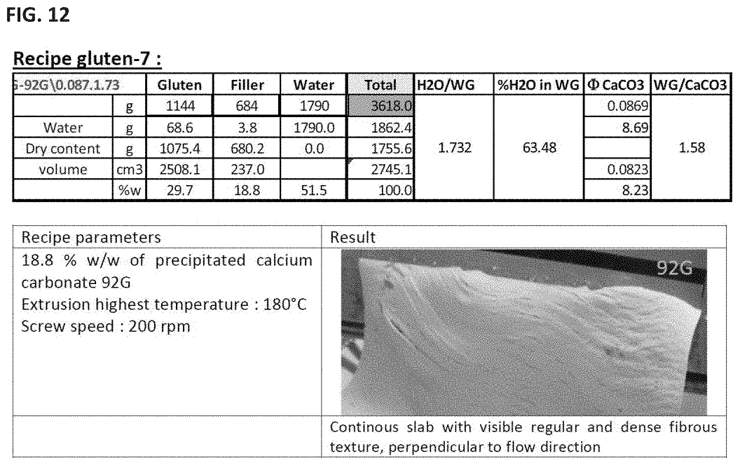

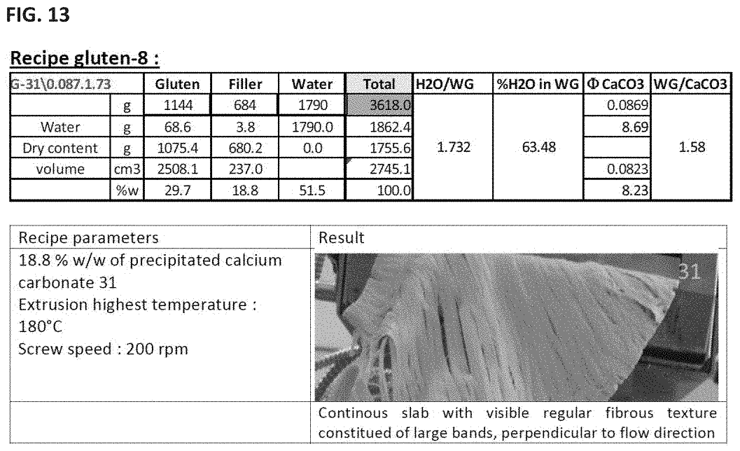

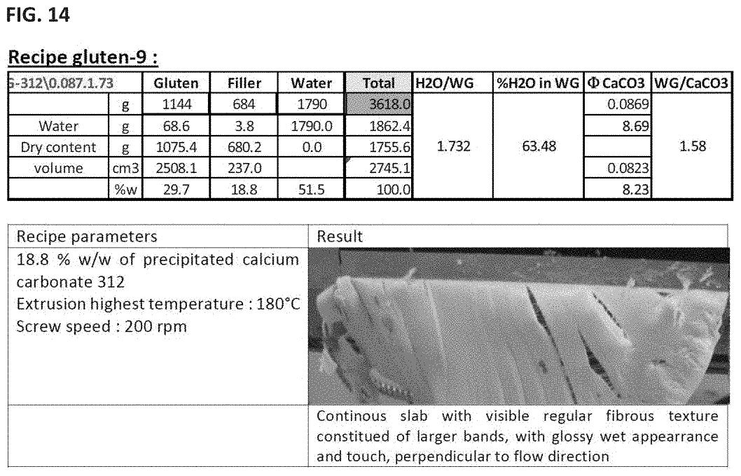

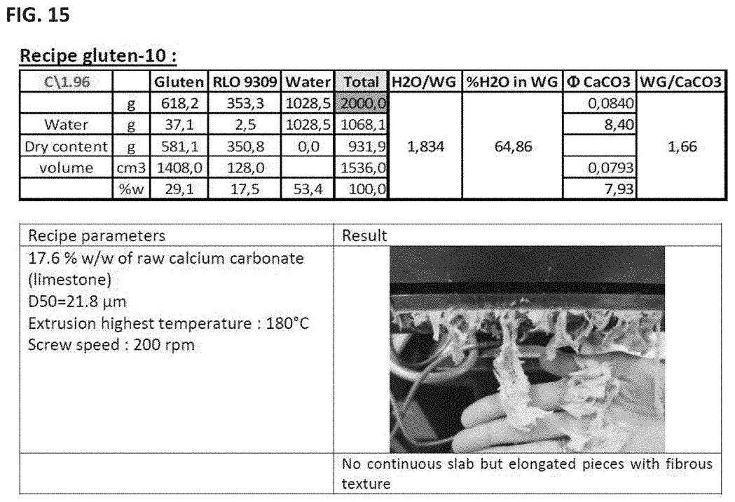

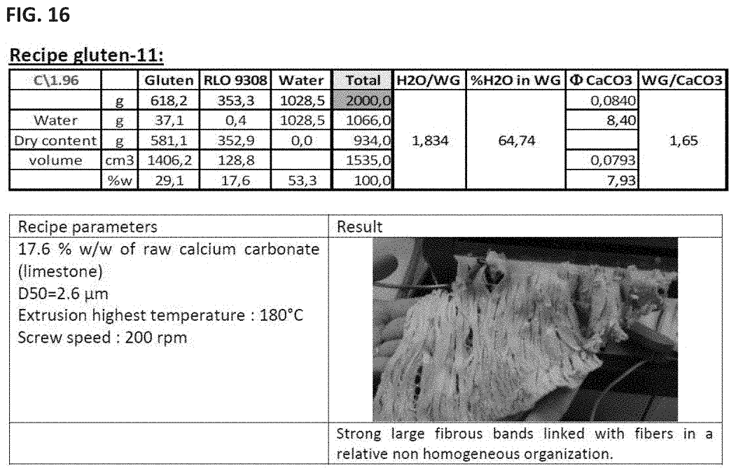

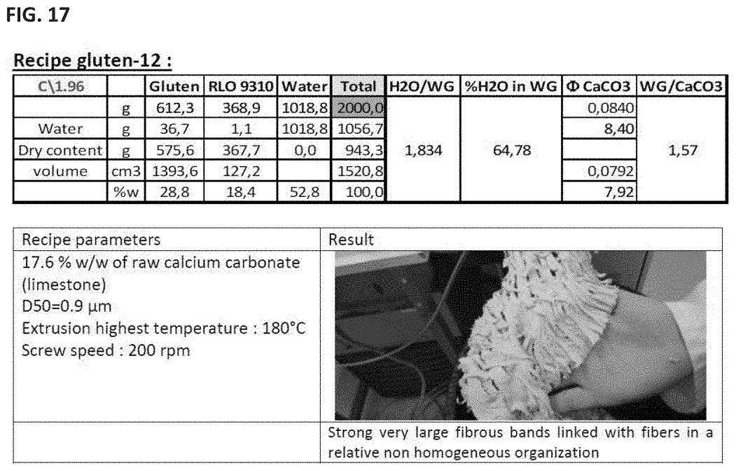

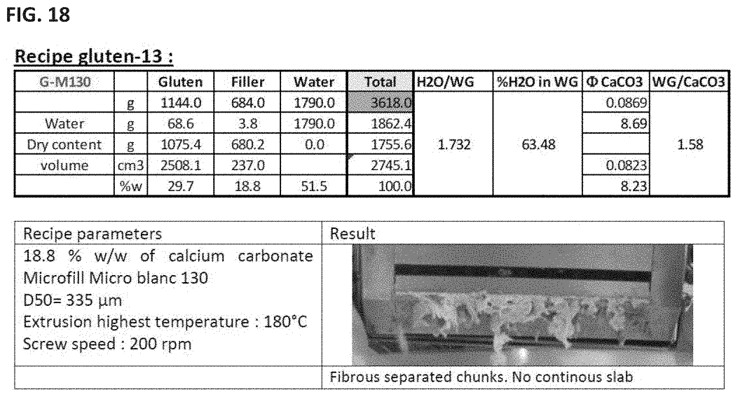

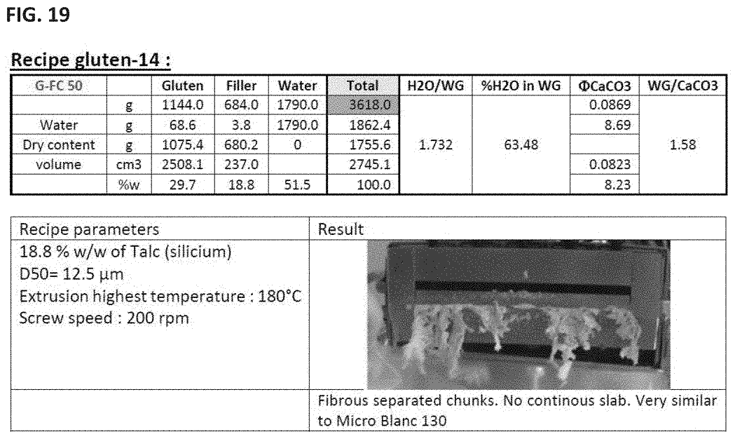

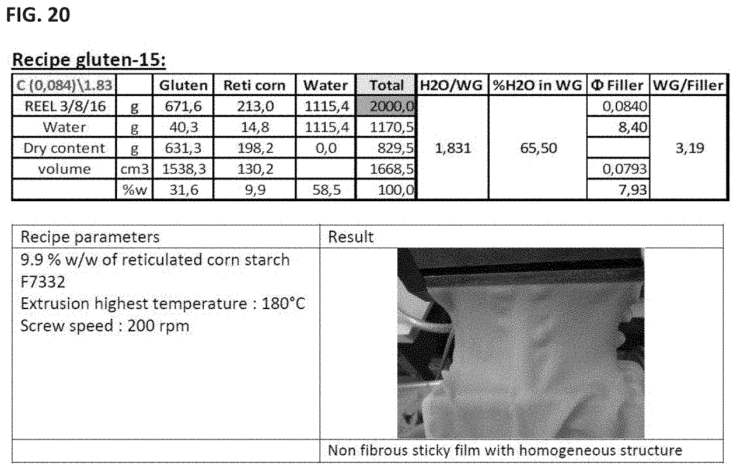

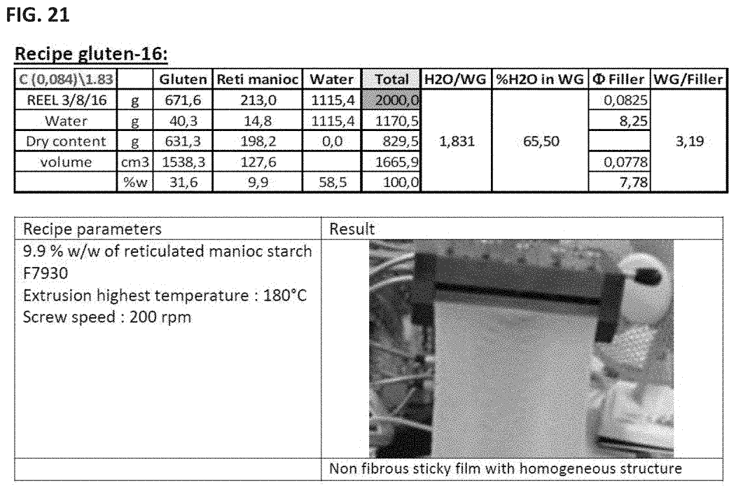

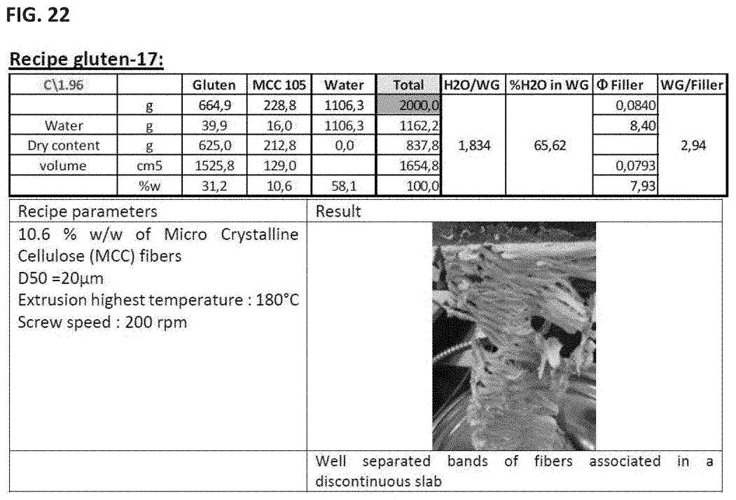

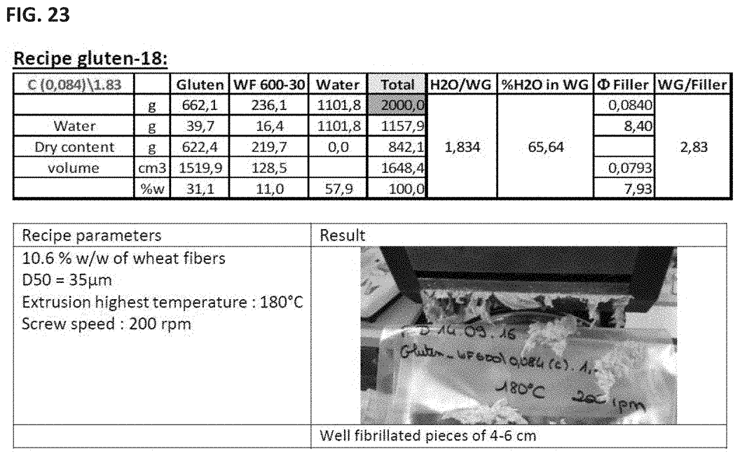

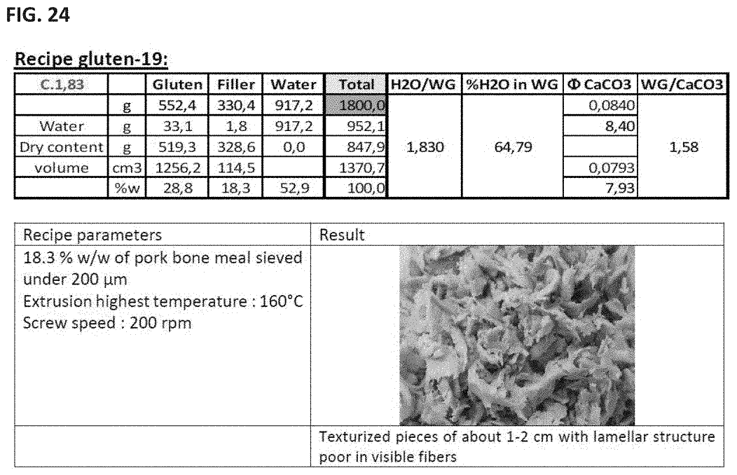

The table in FIG. 5 identifies the main characteristics of particles that were tested. These particles were tested with a standard wheat gluten/water (WG/H2O) ratio of 1.83, corresponding to 65% (w/w) water in gluten. The wheat gluten/particles (filler) ratio was adjusted taking into account apparent density of the particle powder in order to have a roughly equivalent volume ration of particles in protein matrices. Results of each trial with the different tested particles and also with different volume fraction of PCC 1RE are given in FIGS. 6-24, with a description of the used recipes and with picture of the obtained structures.

Regarding the effect of the particle size, the conclusion that was given with calcium carbonate particles seems to be valid. Indeed, when fiber size is too long, the slab becomes discontinuous. However, the limit between well-organized fibers network and non-continuous fibers slabs seems to be at a higher concentration. Indeed, fibers of 20 μm are still able to lead to semi continuous slabs, while for spherical particles the limit was around 5-10 μm.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-13. (canceled)

14. A food for an animal, the food comprising a meat analogue, wherein the meat analogue comprises a fibrous and lamellar structure comprising a protein emulsion comprising a protein and from about 1% to about 30% by weight of added insoluble particles in the protein emulsion, the particles having a solubility in water of about 0.0001 mg/L to about 25 mg/L at 25° C. and a median particle size of about 0.05 μm to about 100 μm.

15. The food of claim 14, wherein the animal is a human, a cat or a dog.

16. A method of producing a meat analogue, the method comprising:
mixing a protein, water and a particle to form an emulsion, wherein the emulsion comprises from about 1% to about 30% by weight of an added insoluble particle, the particle having a solubility in water of about 0.0001 mg/L to about 25 mg/L at 25° C. and a median particle size of from about 0.05 μm to about 100 μm;
heating the emulsion to temperature of about 80° C. to about 200° C. by subjecting the emulsion to extrusion through a die; and
cooling the heated emulsion to form the meat analogue, wherein the meat analogue comprises a fibrous and lamellar structure.

17. The method of claim 16, wherein a heat exchanger is used to cool the heated emulsion.

18. The method of claim 16, further comprising cutting the meat analogue to form chunks.

19. The method of claim 18, further comprising combining the chunks with a comestible composition to form a blended food composition; and retorting or pasteurizing the blended food composition in a container.

20. The method of claim 16, comprising maintaining a temperature of the die at about 80° C. to about 90° C.

21. The method of claim 16, wherein the added insoluble particles comprise a mineral material and a starch.
